(19) United States
(12) Patent Application Publication
(10) Pub. No.: US 2013/0307693 A1
(43) Pub. Date: Nov. 21, 2013

(54) SYSTEM AND METHOD FOR REAL TIME DATA ANALYSIS

(71) Applicant: TRANSPORTATION SECURITY ENTERPRISES, INC. (TSE), El Dorado Hills, CA (US)

(72) Inventors: Douglas M. Stone, Placerville, CA (US); Patrick Harrington, Sacramento, CA (US)

(73) Assignee: TRANSPORTATION SECURITY ENTERPRISES, INC. (TSE), El Dorado Hills, CA (US)

(21) Appl. No.: 13/662,436

(22) Filed: Oct. 27, 2012

Related U.S. Application Data
(60) Provisional application No. 61/649,346, filed on May 20, 2012.

(51) Int. Cl. G08B 23/00; G08B 21/00

(52) U.S. Cl. 340/573.1; 340/540

(57) ABSTRACT

A system and method for real time data analysis are disclosed. A particular embodiment includes; receiving a plurality of current data streams from a plurality of sensor arrays deployed at a monitored venue; correlating the current data streams with corresponding historical data streams and related data streams; analyzing, by use of a data processor, the data streams to identify patterns of activity, behavior, and/or status occurring at the monitored venue; applying one or more rules of to rule set to the analyzed data streams to determine if an alert should he issued; and dispatching an alert if such alert is determined to be warranted.

### PRIORITY PATENT APPLICATION

This non-provisional patent application claims priority to U.S. provisional patent application, Ser. No. 61/649,346; filed on May 20, 2012 by the same applicant as the present patent application. This present pa tent application draws priority from the referenced provisional patent application. The entire disclosure of the referenced provisional patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document Copyright 2010-2012, Transportation Security Enterprises, Inc. (TSE); All Rights Reserved.

### TECHNICAL FIELD

This patent application relates to a system and method for use with networked computer and sensor systems, according to one embodiment, and more specifically, to a system and method for real time data analysis.

### BACKGROUND

The inventor of the present application, armed with personal knowledge of violent extremist suicide bomber behaviors, determined that the “insider, lone wolf, suicide bomber” was the most difficult enemy to counter. The inventor, also armed with the history of mass transit passenger rail bombings by violent extremist bombers, determined that the soft target of mass transport was the most logical target. As such, the security of passengers or cargo utilizing various forms of mass transit has increasingly become of great concern worldwide. The fact that many high capacity passenger and/or cargo mass transit vehicles or mass transporters, such as, ships, subways, trains, trucks, buses, and aircraft, have been found to be “soft targets” have therefore increasingly become the targets of hostile or terrorist attacks. The problem is further exacerbated given that there are such diverse methods of mass transit within even more diverse environments. The problem is also complicated by the difficulty in providing a high bandwidth data connection with a mobile mass transit vehicle. Therefore, a very comprehensive and unified solution is required. For example, attempts to screen cargo and passengers prior to boarding have improved safety and security somewhat, but these solutions have been few, non-cohesive, and more passive than active. Conventional systems do not provide an active, truly viable real time solution that can effectively, continuously, and in real time monitor and report activity at a venue, trends in visitor and passenger behavior, and on-board status information for the duration of a vehicle in transit, and in response to adverse conditions detected, actively begin the mitigation process by immediately alerting appropriate parties and systems. Although there have been certain individual developments proposed in current systems regarding different individual aspects of the overall problem, no system has yet been developed to provide an active, comprehensive, fully-integrated real time system to deal with the entire range of issues and requirements involved within the security and diversity of mass transit. In particular, conventional systems do not provide the necessary early detection in real time, and potentially aid in the prevention of catastrophic events. Separate isolated systems that have difficulty aggregating information and are not in real time, nor aggregated against enough information to allow for a composite alert or pre-alert conclusion.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for real time data analysis;

FIG. 2 is a processing flow chart illustrating an example embodiment of a system and method for real time data analysis as described herein; and

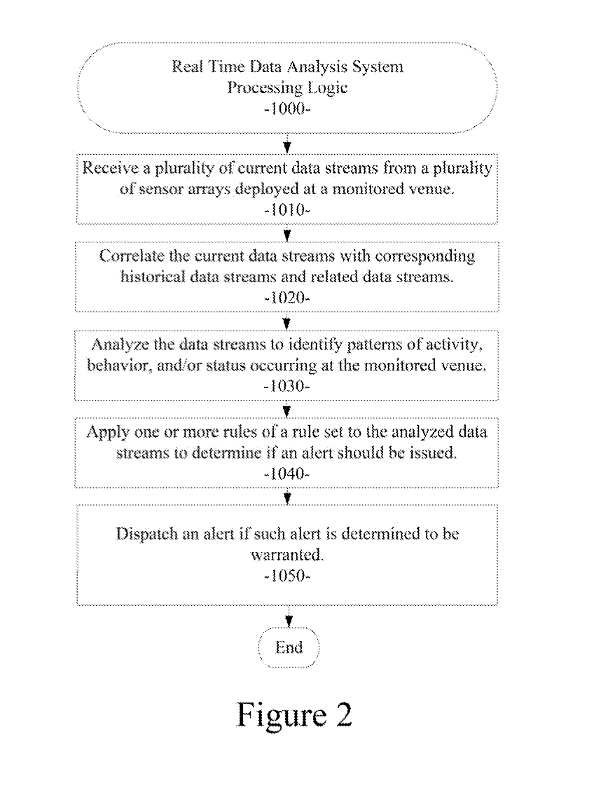

FIG. 3 shows a diagrammatic representation of machine in the example form of a computer system within which a set of instructions when executed may cause the machine to perform any one or more methodologies disclosed herein.

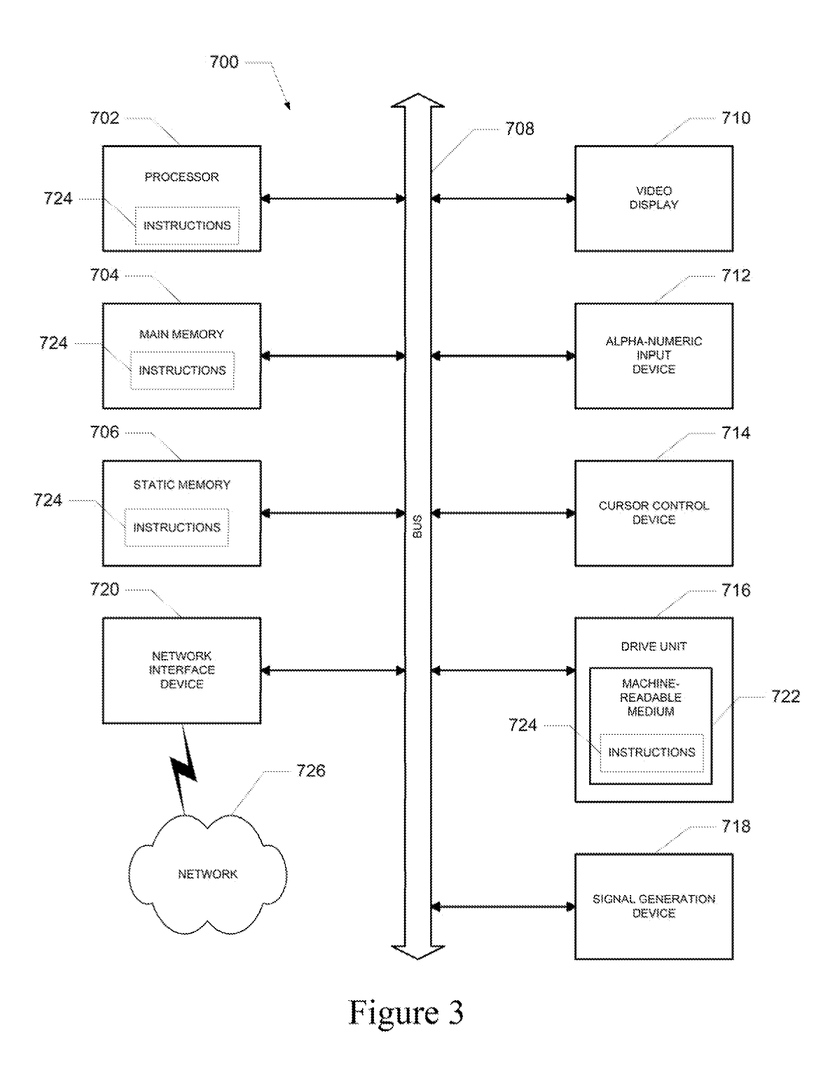

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

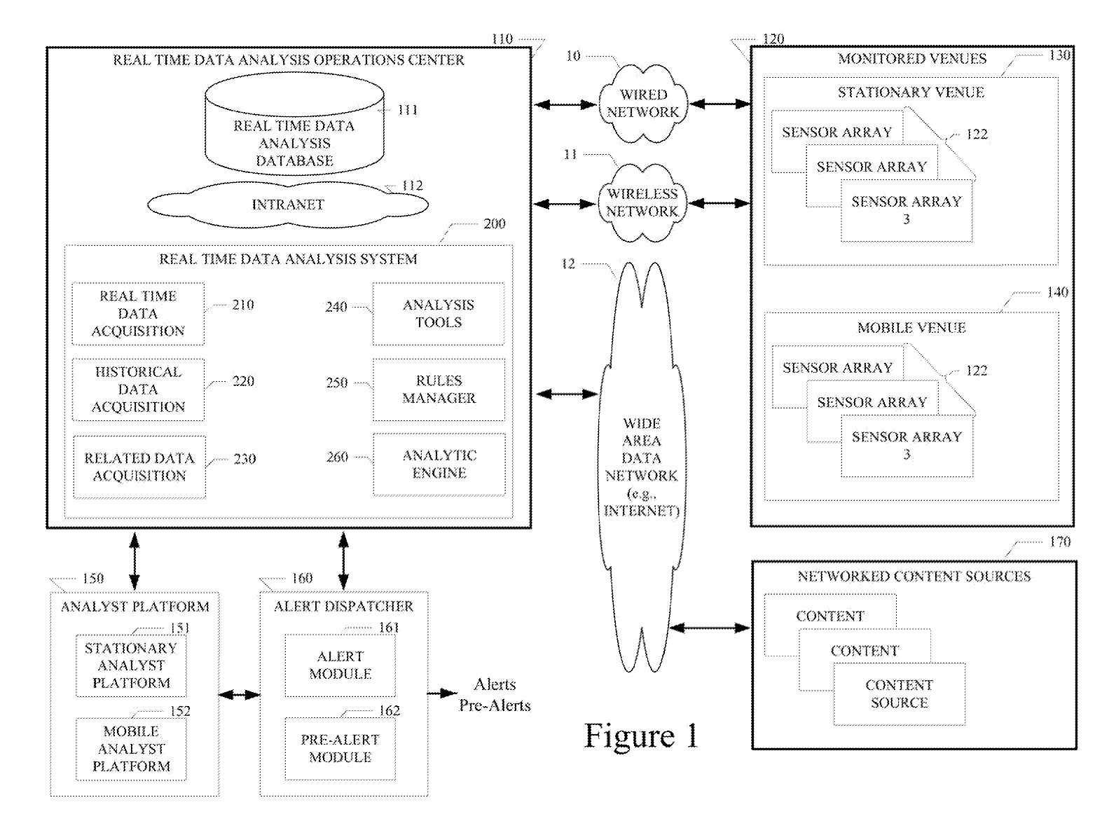

Referring to FIG. 1, in an example embodiment, a system and method for real time data analysis are disclosed. In various example embodiments, a real time data analysis system 200, typically operating in or with a real time data analysis operations center 110, is provided to support the real time analysis of data captured from a variety or sensor arrays. A plurality of monitored venues 120, at which a plurality of sensor arrays 122 are deployed, are in network communication with the real time data analysis operations center 110 via a wired network 10 or a wireless network 11. As described in more detail below, the monitored venues 120 can be stationary venues 130 and/or mobile venues 140. The sensor arrays can be virtually any form of data or image gathering and transmitting device. In one embodiment, a sensor of sensor arrays 122 can include a standard surveillance video camera or other device filar capturing biometrics. The term, ‘biometrics’ refers to unique physiological and/or behavioral characteristics of a person that can be measured or identified. Example characteristics include height, weight, fingerprints, retina patterns, skin and hair color, and voice patterns. Identification systems that use biometrics are becoming increasingly important security tools. Identification systems that recognize irises, voices or fingerprints have been developed and are in use. These systems provide highly reliable identification, but require special equipment to read the intended biometric (e.g., fingerprint pad, eye scanner, etc.) Because of the expense and inconvenience of providing special equipment for gathering these types of biometric data, facial recognition systems requiring only a simple video camera for capturing an image of a face have also been developed. In terms of equipment costs and user friendliness, facial recognition systems provide many advantages that biometric identification systems cannot. For instance, face recognition does not require direct contact with a user and is achievable from relatively far distances, unlike most other types of biometric techniques, e.g., fingerprint and retina scans. In addition, face recognition may be combined with other image identification methods that use the same input images. For example, height and weight estimation based on comparison to known reference objects within the visual field may use the same image as face recognition, thereby providing more identification data without any extra equipment.

In other embodiments, sensor arrays 122 can include motion detectors, magnetic anomaly detectors, metal detectors, audio capture devices, infrared image capture devices, and/or a variety of other of data or image gathering and transmitting devices. Sensor arrays 122 can also include video cameras mounted on a mobile host. In a particularly novel embodiment, a video camera of sensor arrays 122 can be fitted to an animal. For example, camera-enabled head gear can be fitted to a substance-sensing canine deployed in a monitored venue. Such canines can be trained to detect and signal the presence of substances of interest (e.g., explosive material, incendiaries, narcotics, etc.) in a monitored venue. By virtue of the canine's skill in detecting these materials and the camera-enabled head gear fitted to them, these mobile hosts can effectively place a video camera in close proximity to sources of these substances of interest. For example, on a crowded subway platform, a substance-sensing canine can isolate a particular individual among the crowd and place a video camera directly in front of the individual. In this manner, the isolated individual can he quickly and accurately identified, logged, and tracked using facial recognition technology. Conventional systems have no such capability to isolate a suspect individual and capture the suspect's biometrics at a central operations center.

Referring still to FIG. 1, real time data analysis operations center 110 of an example embodiment is shown to include a real time data analysis system 200, intranet 112, and real time data analysis database 111, Real time data analysis system 200 includes real time data acquisition module 210, historical data acquisition module 220, related data acquisition module 230, analysis tools module 240, rules manager module 250, and analytic engine 260. Each of these modules can be implemented as software components executing within an executable. environment of real time data analysis system 200 operating at or with real time data analysis operations center 110. Each of these modules of an example embodiment is described in more detail below in connection with the figures provided herein.

An example embodiment can take multiple and diverse sensor input from sensor arrays 122 at the monitored venues 120 and produce sensor data streams that can be transferred across wired network 10 and/or wireless network 11 to real time data analysis operations center 110 in near real time. The real time data analysis operations center 110 and the real time data analysis system 200 therein acquires, extracts, and retains the information embodied in the sensor data streams within a privileged database 111 of operations center 110 using real time data acquisition module 210. For the stationary venues 130, wired networks 10 and/or wireless networks 11 can be used to transfer the current sensor data streams to the operations center 110. Given the deployment of the sensor arrays 122 and the multiple video feeds that can result, a significant quantity of data may need to be transferred across wired networks 10 and/or wireless networks 11. Nevertheless, the appropriate resources can be deployed to support the data transfer bandwidth requirements. However, supporting the mobile venues 140 can he more challenging. The mobile venues 140 can include mass transit vehicles, such as trains, ships, ferries, buses, aircraft, automobiles, trucks, and the like. The embodiments disclosed herein include a broadband wireless data transceiver capable of high data rates to support the wireless transfer of the current sensor data streams to the operations center 110. As such, the wireless networks 11, including a high-capacity broadband wireless data transceiver, can be used to transfer the current sensor data streams from mobile venues 140 to the operations center 110. In some cases, the mobile venues 140 can include a wired data transfer capability. For example, some train or subway systems include fiber, optical, or electrical data transmission lines embedded in the railway tracks of existing rail lines. These data transmission lines can also he used to transfer the current sensor data streams to the operations center 110. As such, the wired networks 10, including embedded data transmission lines, can also he used to transfer the current sensor data streams from mobile venues 140 to the operations center 110.

In real time, the acquired sensor data streams can be analyzed by the analysis tools module 240, rules manager module 250, and analytic engine 260. The acquired real time sensor data streams are correlated with corresponding historical data streams obtained from, the sensor arrays 122 in prior time periods and corresponding, related data streams obtained from other data sources, such as network-accessible databases (e.g., motor vehicle licensing databases, criminal registry databases, intelligence databases, etc.). The historical data streams arc acquired, retained, and managed by the historical data acquisition module 220. The related data streams are acquired, retained, and managed by the related data acquisition module 230. In some cases, the network-accessible databases providing sources for the related data streams can be accessed using a wide-area data network such as the internet 12. In other cases, secure networks can be used to access the network-accessible databases. As described in more detail below, components within the real time data analysis system 200 can analyze, aggregate, and cross-correlate the acquired real time sensor data streams, the historical data streams, and the related data streams to identify threads of activity, behavior, and/or status present or occurring in a monitored venue 120. In this manner, patterns or trends of activity, behavior, and/or status can be identified and tracked. Over time, these patterns can be captured and retained in database 111 as historical data streams by the historical data acquisition module 220. In many cases, these patterns represent nominal patterns of activity, behavior, and/or status that pose no threat. In other cases, particular patterns of activity, behavior, and/or status can be indicative or predictive of hostile, dangerous, illegal, or objectionable behavior or events.

The various embodiments described herein can isolate and identify these potentially threating patterns of activity, behavior, and/or status and issue alerts or pre-alerts in advance of undesirable conduct. In some cases, a potentially threating pattern can be identified based on an analysis of a corresponding historical data stream. For example, a particular individual present in a particular monitored venue 120 can be identified using the real time data acquired from the sensor arrays 122 and the facial recognition techniques described above. This individual can be assigned a unique identity by the real time data analysis system 200 to both record and track the individual within the system 200 and to protect the privacy of the individual. Using the real time data acquired from the sensor arrays 122, the behavior of the identified individual can be tracked and time-tagged in a thread of behavior as the individual moves through the monitored venue 120. In a subsequent time period (e.g., the following day), the same individual may be identified in the same monitored venue 120 using the facial recognition techniques. Given the facial recognition data, the unique identity assigned to the individual in a previous time period can be correlated to the same individual in the current time period. Similarly, the thread of behavior corresponding to the individual's identity in a previous time period can be correlated to the individual's thread of behavior in the current time period. In this manner, the behavior of a particular individual can be compared with the historical behavior of the same individual from a previous time period. This comparison between current behaviors, activity, or status with historical behaviors, activity, or status from a previous time period may reveal particular patterns or deviations of activity, behavior, and/or status that can be indicative or predictive of hostile, dangerous, illegal, or objectionable behavior or events. For example, an individual acting differently today compared with consistent behavior in the prior month may be indicative of imminent conduct.

In a similar manner, the individual's current and/or historical behaviors at a first monitored venue can be compared with the individual's current and/or historical behaviors at a second monitored venue. In some cases, the threads of behavior at one venue may be indicative of behavior or conduct at a different venue. Thus, the various embodiments described herein can identify and track these threads of behaviors, activities, and/or status across various monitored venues and across different time periods.

Additionally, the various embodiments described herein can also acquire and use related data to further qualify and enhance the analysis of the real time data received from the sensor arrays 122. In an example embodiment, the related data can include related data streams obtained from other data sources, such as network-accessible databases (e.g., motor vehicle licensing databases, criminal registry databases, intelligence databases, etc.). The related data can also include data retrieved from local databases. In general, the related data streams provide an additional information source, which can be correlated to the information extracted from the real time data streams. For example, the analysis of the real time data stream from the sensor arrays 122 of a monitored venue 120 may be used to identify a particular individual present in the particular monitored venue 120 using the facial recognition techniques described above. Absent any related data, it may be difficult to determine if the identified individual poses any particular threat. However, the real time data analysis system 200 of an example embodiment can acquire related data from a network-accessible data source, such as content sources 170. The facial recognition data extracted from the real time data stream can be used to index a database of a network-accessible content source 170 to obtain data related to the identified individual. For example, the extracted facial recognition data can be used to locate and acquire driver license information corresponding to the identified individual from as motor vehicle licensing database. Similarly, the extracted facial recognition data can he used to locate and acquire criminal arrest warrant information corresponding to the identified individual from as criminal registry database. It will be apparent to those of ordinary skill in the art that a variety of information related to an identified individual can be acquired from a variety of network-accessible content sources 170 using the real time data analysis system 200 of an example embodiment.

The various embodiments described herein can use the current real time data streams, the historical data streams, and related data streams to isolate and identify potentially threating patterns of activity, behavior, and/or status in a monitored venue and issue alerts or pre-alerts in advance of undesirable conduct. In real time, the acquired sensor data streams can be analyzed by the analysis tools module 240, rules manager module 250, and analytic engine 260. Analysis tools module 240 includes a variety of functional components for parsing, filtering, sequencing, synchronizing, prioritizing, and marshaling the current data streams, the historical data streams, and the related data streams for efficient processing by the analytic engine 260. The rules manager module 250 embodies sets of rules, conditions, threshold parameters, and the like, which can be used to define thresholds of activity, behavior, and/or status that should trigger a corresponding alert, pre-alert, and/or action. For example, a rule can be defined that specifies that; 1) when an individual enters a monitored venue 120 and is identified by facial recognition, and 2) the same individual is matched to an arrest warrant using, a related data stream, then 3) an alert should be automatically issued to the appropriate authorities. A variety of rules having a construct such as, “IF <Condition> THEN <Action>” can be generated and. managed by the rules manager module 250. Additionally, an example embodiment includes an automatic rule generation capability, which can automatically generate rules given desired outcomes and the conditions by which those desired outcomes are most likely. In this manner, the embodiments described herein can implement machine learning processes to improve the operation of the system over time. Moreover, an embodiment can include information indicative of a confidence level corresponding to a probability level associated with a particular condition and/or need for action.

The analytic engine 260 can cross-correlate the current data streams, the historical data streams, and the related data streams to detect patterns, trends, and deviations therefrom. The analytic engine 260 can detect normal and non-normal activity, behavior, and/or status and activity, behavior, and/or status that is consistent or inconsistent with known patterns of concern using cross-correlation between data streams and/or rules-based analysis. As a result, information can be passed by the real time data analysis system 200 to the analyst platform 150.

The analyst platform 150 represents as stationary analyst platform 151 or as mobile analyst platform 152 at which a human analyst can monitor the analysis information presented by the real time data analysis system 200 and issue alerts or pre-alerts via the alert dispatcher 160. An alert can represent a rules violation. A pre-alert can represent the anticipation of an event. The analyst platform 150 can include a computing platform with a data communication and information display capability. The mobile analyst platform 152 can provide a similar capability in a mobile platform, such as a truck or van. Wireless data communications can be provided to link the mobile analyst platform 152 with the operations center 110.

The alert dispatcher 160 represents a variety of communications channels by which alerts or pre-alerts can be transmitted. These communication channels can include electronic alerts, alarms, automatic telephone calls or pages, automatic emails or text messages, or a variety of other modes of communication. In one embodiment, the alert dispatcher 160 is connected directly to real time data analysis system 200. In this configuration, alerts or pre-alerts can be automatically issued based on the analysis of the data streams without involvement by the human analyst. In this manner, the various embodiments can quickly, efficiently, and in real time respond to activity, behavior, and/or status events occurring in a monitored venue 120.

Networks 10, 11, 12, and 112 are configured to couple one computing device with another computing device. Networks 10, 11, 12, and 112 may be enabled to employ any form of computer readable media for communicating information from one electronic device to another. Network 10 can be a conventional form of wired network using conventional network protocols, Network 11 can be a conventional form of wireless network using conventional network protocols. Proprietary data sent on networks 10, 11, 12, and 112 can be protected using conventional encryption technologies.

Network 12 can include a public packet-switched network, such as the Internet, wide area networks (WANs), direct connections, such as through a universal serial bus (USB) port, other forms of computer-readable media, or any combination thereof. On an interconnected set of LANs, including, those based on differing architectures and protocols, a router or gateway acts as a link between LANs, enabling messages to he sent between computing devices. Also, communication links within LANs typically include twisted wire pair or coaxial cable links, while communication links between networks may utilize analog, telephone lines, full or fractional dedicated digital lines including T1, T2, T3, and T4, Integrated Services Digital Networks (ISDNs), Digital User Lines (wireless links including satellite links, or other communication links known to those of ordinary skill in the art.

Network 11 may further include any of a variety of wireless nodes or sub-networks that may further overlay stand-alone ad-hoc networks, and the like, to provide an infrastructure-oriented connection. Such sub-networks may include mesh networks, Wireless LAN it WLAN) networks, cellular networks, and the like. Network 11 may also include an autonomous system of terminals, gateways, routers, and the like connected by wireless radio links or wireless transceivers. These connectors may be configured to move freely and randomly and organize themselves arbitrarily, such that the topology of network 11 may change rapidly,

Network 11 may further employ a plurality of access technologies including 2nd (2G), 2.5, 3rd (3G), 4th (4G)generation radio access for cellular systems, WLAN, Wireless Router (WR) mesh, and the like. Access technologies such as 2G, 3G, 4G, and future access networks may enable wide area coverage for mobile devices, such as one or more client devices with various degrees of mobility. For example, network 11 may enable a radio connection through a radio network access such as Global System for Mobile communication (GSM), General Packet Radio Services (GPRS), Enhanced Data GSM Environment (EDGE), Wideband Code. Division Multiple Access (WCDMA), CDMA2000, and the like.

Network 10 may include any of a variety of nodes interconnected via a wired network connection. Such wired network connection may include electrically conductive wiring, coaxial cable, optical fiber, or the like. Typically, wired networks can support higher bandwidth data transfer than similarly configured wireless networks. For legacy network support, remote computers and other related electronic devices can he remotely connected to either LANs or WANs via as modem and temporary telephone link.

Networks 10, 11, 12, and 112 may also be constructed for use with various other wired and wireless communication protocols, including TCP/IP, UDP, SIP, SMS, RTP, WAP, CDMA, TDMA, EDGE, UMTS, GPRS, GSM, MB, WiMax, IEEE 802.11x, and the like. In essence, networks 10, 11, 12, and 112 may include virtually any wired and/or wireless communication mechanisms by which information may travel between one computing device and another computing device, network, and the like. In one embodiment, network 112 may represent a LAN that is configured behind a firewall (not shown), within a business data center, for example.

The content sources 170 may include any of a variety of providers of network transportable digital content. This digital content can include as variety of content related to the monitored venues 120 and/or individuals or events being monitored within the monitored venue 120. The networked content is often available in the form of a network transportable digital file or document. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion. Picture Experts Group. Audio Layer 3-MP3, and the like), video (e.g., MP4, and the like), and any proprietary interchange format defined, by specific content sites be supported by the various embodiments described herein.

In a particular embodiment, the analyst platforn 150 and the alert dispatcher 160 can include a computing platform with one or more client devices enabling an analyst to access information from operations center 110. These client devices may include virtually any computing device that is configured to send and receive information over a network or a direct data connection. The client devices may include computing devices, such as personal computers (PCs), multiprocessor systems, microprocessor-based or programmable consumer electronics, network PC's, and the like. Such client devices may also include mobile computers, portable devices, such as, cellular telephones, smart phones, display pagers, radio frequency (RE) devices, infrared (IR) devices, global positioning devices (GPS), Personal Digital Assistants (PDAs), handheld computers, wearable computers, tablet computers, integrated devices combining one or more of the preceding devices, and the like, As such, the client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission or a direct data connection. The client application may include a capability to provide and receive textual content, graphical content, video content, audio content, alerts, messages, notifications, and the like. Moreover, client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. Client devices may also include a wireless application device on which a client application is configured to enable a user of the device to send and receive information to/from network sources wirelessly via a network.

FIG. 9 is a processing flow diagram illustrating an example embodiment of a system and method for real time data analysis as described herein. The method of an example embodiment includes: receiving a plurality of current data streams from a plurality of sensor arrays deployed at a monitored venue (processing block 1010); correlating the current data streams with corresponding historical data streams and related data streams (processing block 1020); analyzing, by use of a data processor, the data streams to identity patterns of activity, behavior, and/or status occurring at the monitored venue (processing block 1030); applying one or more rules of a rule set to the analyzed data streams to determine if an alert should be issued (processing block 1040); and dispatching an alert if such alert is determined to be warranted (processing block 1050).

FIG. 10 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-dient network environment, or as a peer machine in a peer-to-peer (or distributed) network environment. The machine may be a personal computer (PC), a tablet PC, a set-top box (SIB), a Personal Digital Assistant (PDA), a cellular telephone, a web appliance, a network router, switch or bridge, or any machine capable of executing a set of instructions (sequential or otherwise) that specify actions to he taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (CPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further he transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited, to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A method comprising:
receiving a plurality of current data streams from a plurality of sensor arrays deployed at a monitored venue;
correlating the current data streams with corresponding historical data streams and related data streams;
analyzing, by use of a data processor, the data streams to identify patterns of activity, behavior, and/or status occurring at the monitored venue:
applying one or more rules of a rule set to the analyzed data streams to determine if an alert should be issued; and
dispatching an alert if such alert is determined to be warranted.

2. The method as claimed in claim 1 wherein the monitored venue is a mobile venue.

3. The method as claimed in claim 2 wherein the mobile venue is from the group: mass transit vehicle, military vehicle, train, railcar, ship, ferry, buses, aircraft, automobile, and truck.

4. The method as claimed in claim I wherein the plurality of current data streams includes sensor data video data, and audio data,

5. The method as claimed in claim 1 wherein at east one of the plurality of current data streams is received via wireless network.

6. The method as claimed in claim 1 wherein analyzing the data streams to identify patterns of activity, behavior, and/or status occurring at the monitored venue includes determining if identified patterns of activity, behavior, and/or status are indicative or predictive of hostile, dangerous, illegal, or objectionable behavior or events.

7. The method as claimed in claim 1 wherein analyzing the data streams to identify patterns of activity, behavior, and/or status occurring at the monitored venue includes performing facial recognition on at least one individual in the monitored venue.

8. The method as claimed in claim 1 wherein analyzing the data streams to identify patterns of activity, behavior, and/or status occurring at the monitored venue includes comparing activity, be and/or status occurring at a first monitored venue with activity, behavior, and/or status occurring at a second monitored venue.

9. The method as claimed in claim 1 wherein the rule set includes sets of rules, conditions, and threshold parameters, which are used to define thresholds of activity, behavior, and/or status that trigger a corresponding alert, pre-alert, and/or action.

10. A system comprising:
a plurality of set deployed at a monitored venue; and
a real time data analysis operations center in data communication with the plurality of silt arrays via a wired or wireless network, the real time data analysis operations center including computing modules to:
receive a plurality of current data streams from the plurality of sensor arrays deployed the monitored venue:
correlate the current data streams with corresponding historical data streams and related data streams;
analyze the data streams to identify patterns of activity, behavior, as and/or status occurring at the monitored venue;
apply one or more rules of a rule set to the analyzed data streams to determine if an alert should be issued; and
dispatch an alert if such alert is determined to be warranted.

11. the system as claimed in claim 10 wherein the monitored venue is a mobile venue.

12. The system as claimed in claim 11 wherein the mobile venue is from the group: mass transit vehicle, military vehicle, train, railcar, ship, ferry, buses, aircraft, automobile, and truck.

13. The system as claimed in claim 10 wherein the plurality of current data streams includes sensor data, video data, and audio data.

14. The system as claimed in claim 10 wherein at least one of the plurality of current data streams is received via a wireless network.

15. The system as claimed in claim 10 being further configured to determine if identified patterns of activity, behavior, and/or status are indicative or predictive of hostile, dangerous, illegal, or objectionable behavior or events.

16. The system as claimed in claim 10 being further configured to perform facial recognition on at least one individual in the monitored venue.

17. The system as claimed in claim 10 being further configured to compare activity, behavior. and/or status occurring at a first monitored venue with activity, behavior, and/or status occurring at a second monitored venue.

18. The system as claimed in claim 10 wherein the rule set includes sets of rules, conditions, and threshold parameters, which are used to define thresholds of activity, behavior, and/or status that trigger a corresponding alert, pre-alert, and/or action.

19. A non-transitory machine-useable storage medium embodying instructions which, when executed by a machine, cause the machine to
receive a plurality of current data streams from the plurality of sensor arrays deployed at the monitored venue;
correlate the current data streams with corresponding historical data streams and related data. streams;
analyze the data streams to identify patterns of activity, behavior, and/or status occurring at the monitored venue;
apply one or more rules of a rule set to the analyzed data streams to determine if an alert should be issued; and
dispatch an alert if such alert is determined to he warranted.

20. The machine-useable storage medium as claimed in claim 19 wherein the monitored venue is a mobile venue.
